(19) United States
(12) Patent Application Publication
(10) Pub. No.: US 2002/0022585 A1
(43) Pub. Date: Feb. 21, 2002

(54) Detergent compositions with improved whitening benefits and methods and articles employing same

(75) Inventors: Joseph Paul Morelli, Bothell, WA (US); Eugene Paul Gosselink, Cincinnati, OH (US); Robert Henry Rohrbaugh, Indian Springs, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/866,104

(22) Filed: May 25, 2001

Related U.S. Application Data
(60) Provisional application No. 60/207,936, filed on May 30, 2000.

(51) Int. Cl. C11D 3/37

(52) U.S. Cl. 510/475; 510/476

(57) ABSTRACT

Detergent compositions, specifically laundry detergent compositions comprising agents, specifically water soluble polymers, for providing cleaning and improved whitening of fabrics contacted by such detergent compositions; and methods and articles employing such detergent compositions are provided. More specifically, the present invention relates to laundry detergent compositions comprising vinyl addition polymers derived from (i) monoethylenically unsaturated C₃₋₈ monocarboxylic acids, C₄₋₈ dicarboxylic acids, their salts and mixtures thereof; (ii) hydrophilic ethylenically unsaturated monomers containing at least one poly(oxyethylene) group; and (iii) hydrophobic ethylenically unsaturated monomers with a water solubility of less than 1%. The laundry detergent compositions of the present invention provide improved whitening benefits compared to conventional laundry detergent compositions.

### RELATED APPLICATIONS

This application claims priority under 35 USC §119(a)-(d) of U.S. Provisional Application No. 60/207,936, filed May 30, 2000.

### FIELD OF THE INVENTION

The present invention relates generally to detergent compositions, specifically laundry detergent compositions comprising agents, specifically water soluble polymers, for providing cleaning and improved whitening of fabrics contacted by such detergent compositions; and methods and articles employing such detergent compositions. More specifically, the present invention relates to laundry detergent compositions comprising vinyl addition polymers derived from (i) monoethylenically unsaturated C₃₋₈ monocarboxylic acids, C₄₋₈ dicarboxylic acids, their salts and mixtures thereof; (ii) hydrophilic ethylenically unsaturated monomers containing at least one poly(oxyethylene) group; and (iii) hydrophobic ethylenically unsaturated monomers with a water solubility of less than 1%. The laundry detergent compositions of the present invention provide improved whitening benefits compared to conventional laundry detergent compositions.

### BACKGROUND OF THE INVENTION

Consumers desire to have the cleanest and most vibrant fabrics, especially with respect to white fabrics, that technology can provide. Accordingly, there is a never-ending need for formulators to develop laundry detergent compositions that satisfy the needs of the consumers by providing improved cleaning and whitening benefits to fabrics.

White fabrics, through use and/or wear, are susceptible to dingy stains and other forms of stains. Consumers desire to have these dingy stains and other forms of stains completely removed from the fabric.

Prior art attempts at satisfying such consumers needs included incorporating various type of enzymes and optical brighteners into the laundry detergents.

However, such prior art attempts have not been totally satisfactory to the consumers. Accordingly, there remains a need to develop laundry detergent compositions and methods for using such compositions to provide cleaning and improved whitening benefits over conventional detergents.

### SUMMARY OF THE PRESENT INVENTION

The present invention fulfills the needs identified above by providing detergent compositions, preferably laundry detergent compositions comprising a water soluble polymer, preferably a vinyl addition polymer that provides improved cleaning and whitening benefits to fabrics contacted by such laundry detergent.

In one aspect of the present invention, a laundry detergent composition comprising (a) a vinyl addition polymer derived from (i) monoethylenically unsaturated C₃₋₈ monocarboxylic acids, C₄₋₈ dicarboxylic acids, their salts and mixtures thereof; (ii) hydrophilic ethylenically unsaturated monomers containing at least one poly(oxyethylene) group; and (iii) hydrophobic ethylenically unsaturated monomers having a water solubility of less than 1%; and (b) one or more cleaning adjunct materials, is provided.

In another aspect of the present invention, a laundry detergent composition comprising:

(a) 10-75% by wt of at least one anionic, nonionic, cationic, ampholytic, or zwitterionic surfactant and mixtures thereof;

(b) 0.01-1% by wt of at least one fluorescent whitening agent;

(c) 0.01-10% by wt of a water soluble vinyl addition polymer derived from:

I. 1-60% by wt of monoethylenically unsaturated C₃₋₈ monocarboxylic acid, C₄₋₈ dicarboxylic acid, their salts, and mixtures therein;

II. 5-85% by wt of hydrophilic ethylenically unsaturated monomers containing at least one poly(oxyethylene) group wherein the weight fraction of the sum of all oxyethylene groups is greater than 0.55 of the monomer formula weight;

III. 10-85% by wt of hydrophobic ethylenically unsaturated monomer with a water solubility of less than 1%; and

IV. 0-30% by wt of polymerizable ethylenically unsaturated monomers different from I, II, and III,

is provided.

In still another aspect of the present invention, a laundry detergent composition comprising:

(a) 10-75% by wt of at least one anionic, nonionic, cationic, ampholytic, or zwitterionic surfactant and mixtures thereof;

(b) 0.01-1% by wt of at least one fluorescent whitening agent;

(c) 0.01-10% by wt of a water soluble vinyl addition polymer prepared by an emulsion polymerization process;

is provided.

In still yet another aspect of the present invention, a laundry detergent composition comprising:

(a) 10-75% by wt of at least one anionic, nonionic, cationic, ampholytic, or zwitterionic surfactant and mixtures thereof;

(b) 0.01-1% by wt of at least one fluorescent whitening agent;

(c) 0.01-10% by wt of a water soluble vinyl addition polymer prepared by a solution polymerization process;

is provided.

In even yet another aspect of the present invention, a method of removing stains from fabrics comprising contacting the stains with a laundry detergent solution, paste, or slurry comprising:

(a) 0.005-75% by wt of at least one anionic, nonionic, cationic, ampholytic, or zwitterionic surfactant and mixtures thereof;

(b) 0.000005-1% by wt of at least one fluorescent whitening agent;

(c) 0.00005-10% by wt of a water soluble vinyl addition polymer derived from:

I. 1-60% by wt of monoethylenically unsaturated C₃₋₈ monocarboxylic acid, C₄₋₈ dicarboxylic acid, their salts, and mixtures thereof;

II. 5-85% by wt of hydrophilic ethylenically unsaturated monomers containing at least one poly(oxyethylene) group wherein the weight fraction of the sum of all oxyethylene groups is greater than 0.55 of the monomer formula weight;

III. 10-85% by wt of hydrophobic ethylenically unsaturated monomer with a water solubility of less than 1%; and

IV. 0-30% by wt of polymerizable ethylenically unsaturated monomers different from I, II, and III,

is provided.

In still another aspect of the present invention, a method of removing stains from fabrics comprising contacting the stains with a laundry detergent solution, paste, or slurry comprising:

(a) 0.005-75% by wt of at least one anionic, nonionic, cationic, ampholytic, or zwitterionic surfactant and mixtures thereof;

(b) 0.000005-1% by wt of at least one fluorescent whitening agent;

(c) 0.00005-10% by wt of a water soluble vinyl addition polymer of the formula

-[-A-]-ₘ-[—B—]-ₙ-[—C—]-ₒ-[-D-]-ₚ

wherein:

I. monomer unit -[-A-]- is derived from monoethylenically unsaturated C₃₋₈ monocarboxylic acid, C₄₋₈ dicarboxylic acid, their salts, and mixtures therein;

II. monomer unit -[—B—]- is derived from a hydrophilic ethylenically unsaturated monomer having the formula R-X-G and R-G wherein:

R is selected from the group consisting of CH₂═C(R₁)— where R₁ is H or C₁₋₄ alkyl;

X is selected from the group consisting of —CH₂—, —(C═O)—, and —OCO—;

G is selected from the group consisting of —O—(E)_{q}—R₂ and —N(R₁)—(E)_{q}—R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;

III. monomer unit -[—C—]- is derived from a hydrophobic ethylenically unsaturated monomer having the formula R-Y-L and R-Z wherein:

Y is selected from the group consisting of —CH₂—, —CO₂—, —OCO—, and —CON(R₁)—;

L is selected from the group consisting of saturated C₂₋₂₀ alkyl, C₆₋₁₂ aryl, and C₇₋₂₀ alkylaryl group;

Z is selected from the group consisting of C₆₋₁₂ aryl and C₇₋₁₂ arylalkyl group;

IV. monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-ₘ-[—B—]-ₙ-[—C—]-ₒ-[-D]-ₚ being 100 percent, it being understood that the -[-A-]-, -[—B—]-, -[—C—]-, and -[-D-]- monomers can be arranged in any sequence; and the polymer having a number average molecular weight from 1000 to 100,000,

is provided.

In still yet another aspect of the present invention, a method of improving fabric whiteness appearance of a fabric comprising contacting the fabric with a laundry detergent solution comprising:

(a) 50-5000 ppm of at least one anionic, nonionic, cationic, ampholytic, or zwitterionic surfactant and mixtures thereof;

(b) 0.05-5 ppm of at least one fluorescent whitening agent;

(c) 0.5-500 ppm of a water soluble vinyl addition polymer derived from:

I. 1-60% by wt of monoethylenically unsaturated C₃₋₈ monocarboxylic acid, C₄₋₈ dicarboxylic acid, their salts, and mixtures thereof;

II. 5-85% by wt of hydrophilic ethylenically unsaturated monomers containing at least one poly(ethylene glycol) group wherein the weight fraction of the sum of all oxyethylene groups is greater than 0.55 of the monomer formula weight;

III. 10-85% by wt of hydrophobic ethylenically unsaturated monomer with a water solubility of less than 1%; and

IV. 0-30% by wt of polymerizable ethylenically unsaturated monomers different from I, II, and III,

is provided.

In even still yet another aspect of the present invention, a method of improving fabric whiteness appearance of a fabric comprising contacting the fabric with an aqueous laundry detergent solution comprising:

(a) 50-5000 ppm of at least one anionic, nonionic, cationic, ampholytic, or zwitterionic surfactant and mixtures thereof;

(b) 0.05-5 ppm of at least one fluorescent whitening agent;

(c) 0.5-500 ppm of a water soluble vinyl addition polymer of the formula

-[-A-]-ₘ-[—B—]-ₙ-[—C—]-ₒ-[-D-]-ₚ

wherein:

I. monomer unit -[-A-]- is derived from monoethylenically unsaturated C₃₋₈ monocarboxylic acid, C₄₋₈ dicarboxylic acid, their salts, and mixtures therein;

II. monomer unit -[—B—]- is derived from a hydrophilic ethylenically unsaturated monomer having the formula R-X-G and R-G wherein:

R is selected from the group consisting of CH₂═C(R₁)— where R₁ is H or C₁₋₄ alkyl;

X is selected from the group consisting of —CH₂—, —(C═O)—, and —OCO—;

G is selected from the group consisting of —O—(E)_{q}—R₂ and —N(R₁)—(E)_{q}—R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;

III. monomer unit -[—C—]- is derived from a hydrophobic ethylenically unsaturated monomer having the formula R-Y-L and R-Z wherein:

Y is selected from the group consisting of —CH₂—, —CO₂—, —OCO—, and —CON(R₁)—;

L is selected from the group consisting of saturated C₂₋₂₀ alkyl, C₆₋₁₂ aryl, and C₇₋₂₀ alkylaryl group;

Z is selected from the group consisting of C₆₋₁₂ aryl and C₇₋₁₂ arylalkyl group;

IV. monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-ₘ-[—B—]-ₙ-[—C—]-ₒ-[-D-]-ₚ being 100 percent, it being understood that the -[-A-]-, -[—B—]-, -[—C—]-, and -[-D-]- monomers can be arranged in any sequence; and the polymer having a number average molecular weight from 1000 to 100,000,

is provided.

In yet another aspect of the present invention, a method for treating a fabric in need of treatment comprising contacting said fabric with the laundry detergent composition according to the present invention, is provided.

The water soluble vinyl addition polymers useful in the compositions, processes and/or methods of the present invention may be made using any known technique, for example, solution (aqueous or solvent), emulsion, solvent-exchange or suspension polymerization and/or post-polymerization modifications; the polymerizations can be conducted as cofeed, heel, semi-continuous or continuous processes. The polymers may be random or block polymers depending upon the specific method used to conduct the polymerization. The polymers may be used in solution form, for example as aqueous or organic solvent solutions, or they may be isolated as solid materials, for example by spray drying, and used in the form of granules or particulates.

Accordingly, the present invention provides a detergent compositions that contain agents; namely, polymers, specifically water soluble vinyl addition polymers, that provide whitening benefits; methods for removing stains from fabrics using compositions comprising such water soluble polymers vinyl addition polymers; methods for improving fabric whiteness appearance of a fabric using compositions comprising such water soluble vinyl addition polymers; and methods for treating fabrics using compositions comprising such water soluble vinyl addition polymers.

These and other objects, features and advantages will become apparent to those of ordinary skill in the art from a reading of the following detailed description and the appended claims.

All percentages, ratios and proportions herein are by weight, unless otherwise specified. All temperatures are in degrees Celsius (° C.) unless otherwise specified. All documents cited are in relevant part, incorporated herein by reference.

### DETAILED DESCRIPTION OF THE INVENTION

### Definitions

As used herein, the following terms have the designated definitions, unless the context clearly indicates otherwise. The term “alkyl (meth)acrylate” refers to either the corresponding acrylate or methacrylate ester; similarly, the term “(meth)acrylic” refers to either the corresponding acrylic or methacrylic acid and the corresponding derivatives, such as esters or amides. The term “copolymer” refers to polymer compositions comprising units of two or more different monomers.

“Vinyl Addition Polymer”—herein means those polymers formed from the polymerization of monomers containing a carbon-carbon double bond without the loss of a small molecule.

The vinyl addition polymer of the present invention is derived from (i) monoethylenically unsaturated C₃₋₈ monocarboxylic acids, C₄₋₈ dicarboxylic acids, their salts and mixtures thereof; (ii) hydrophilic ethylenically unsaturated monomers containing at least one poly(oxyethylene) group; and (iii) hydrophobic ethylenically unsaturated monomers having a water solubility of less than 1%; and optionally, monomer derived from polymerizable ethylenically unsaturated monomers other than monomers derived from (i), (ii) and (iii); and (b) one or more cleaning adjunct materials.

Preferably, the vinyl addition polymer has the formula:

-[-A-]-ₘ-[—B—]-ₙ-[—C—]-ₒ-[-D-]-ₚ

wherein:

(a) monomer unit -[-A-]- is derived from monoethylenically unsaturated C₃₋₈ monocarboxylic acid, C₄₋₈ dicarboxylic acid, their salts, and mixtures therein;

(b) monomer unit -[—B—]- is derived from a hydrophilic ethylenically unsaturated monomer having the formula R-X-G and R-G wherein:

R is selected from the group consisting of CH₂═C(R₁)— where R₁ is H or C₁₋₄alkyl;

X is selected from the group consisting of —CH₂—, —(C═O)—, and —OCO—;

G is selected from the group consisting of —O—(E)_{q}-R₂ and —N(R₁)-(E)_{q}-R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;

(c) monomer unit -[—C—]- is derived from a hydrophobic ethylenically unsaturated monomer having the formula R-Y-L and R-Z wherein:

Y is selected from the group consisting of —CH₂—, —CO₂—, —OCO—, and —CON(R₁)—;

L is selected from the group consisting of saturated C₂₋₂₀ alkyl, C₆₋₁₂ aryl, and C₇₋₂₀ alkylaryl group;

Z is selected from the group consisting of C₆₋₁₂ aryl and C₇₋₁₂ arylalkyl group;

(d) monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-ₘ-[—B—]-ₙ-[—C—]-ₒ-[-D-]-ₚ being 100 percent, it being understood that the -[-A-]-, -[—B—]-, -[—C—]-, and -[-D-]- monomers can be arranged in any sequence.

The monoethylenically unsaturated C₃₋₈ monocarboxylic acids and C₄₋₈ dicarboxylic acids are selected from the group consisting of acrylic acid, methacrylic acid, beta-acryloxypropionic acid, vinyl acetic acid, vinyl propionic acid, crotonic acid, ethacrylic acid, alpha-chloro acrylic acid, alpha-cyano acrylic acid, maleic acid, maleic anhydride, fumaric acid, itaconic acid, citraconic acid, mesaconic acid, methylenemalonic acid, their salts, and mixtures thereof.

More preferably, the monoethylenically unsaturated C₃₋₈ monocarboxylic acids, C₄₋₈ dicarboxylic acids, their salts and mixtures thereof, are selected from the group consisting of: acrylic acid, methacrylic acid, maleic acid.

The hydrophilic ethylenically unsaturated monomers are alpha-beta unsaturated poly(C₂₋₄ oxyalkylene) derivatives wherein the monomer contains at least one poly(oxyethylene) group such that the weight fraction of all oxyethylene groups is greater than 0.55 of the monomer formula weight. The poly(C₂₋₄ oxyalkylene) group can be selected from the group consisting of poly(ethylene glycol), poly(propylene glycol), poly(butylene glycol), and mixtures thereof. The hydrophilic poly(C₂₋₄ oxyalkylene) group can be connected to the polymerizabe alpha-beta unsaturated group through various functional groups not limited to esters, amides, ethers, allyl ethers, carbonates, and carbamates.

Preferably, the hydrophilic ethylenically unsaturated monomers containing at least one poly(oxyethylene) group is selected from the group consisting of (meth)acrylate esters, N-substituted (meth)acrylamides, alpha-olefins, allyl ethers, vinyl carbonates, vinyl carbamates, and mixtures thereof wherein the weight ratio fraction of all oxyethylene groups is greater than 0.55 of the formula weight. Even more preferred, the hydrophilic ethylenically unsaturated monomers containing at least one poly(oxyethylene) group is selected such that the poly(oxyethylene) group is capped with a hydrogen or methyl group.

Examples of hydrophilic ethylenically unsaturated monomers include (meth)acrylate esters Bisomer PEA6, Bisomer PEM6E, Bisomer MPEG350MA, Bisomer MPEG550MA, Bisomer S10W, Bisomer S20W manufactured by Laporte Ltd. Hydrophilic N-substituted (meth)acrylamides which can be prepared from Jeffamine M1000 and M2070 poly(oxyalkylene)propylamines manufactured by Huntsman. Other examples of hydrophilic acrylamides include N-[2-[2-(2-hydroxyethoxy)ethoxy]ethoxy]ethyl-2-methyl-2-propenamide and N-[2-[2-(2-methoxyethoxy)ethoxy]ethyl]-2-propenamide. Examples of hydrophilic polyethylene glycol monoallyl ethers include Rhodasurf AA-E-10 (polyethylene glycol [10] monoallyl ether) manufactured by Rhodia. Examples of polyethylene glycol vinyl ethers include triethylene glycol methyl vinyl ether, methoxytetraethylene glycol vinyl ether, 2-[2-[2-(ethyleneoxy)ethoxy]ethoxy]ethanol vinyl ether, and 3,6,9,12,15-pentaoxaheptadec-1-ene.

The hydrophobic monomer is selected such that the water solubility is less than 1% by wt at 25° C. Monomer water solubility can be determined by any appropriate instrumental method through a level study after stirring 24 hours to insure saturation has been achieved. The hydrophobic monomers can be selected from the group consisting of alkyl (meth)acrylate esters, N-alkyl substituted (meth)acrylamides, alpha-olefins, styrene, vinyl esters, vinyl ethers, and mixtures thereof. The water solubility of many common monomers can be found in Monomers: A Collection of Data & Procedures on Basic Materials for the Synthesis of Fibers, Plastics & Rubbers Ed. E. R. Blout, H. Mark (Interscience, N.Y., 1951) and Kirk Othmer Encyclopedia of Chemical Technology 4^{th} Edition, Volume 15, page 55.

Preferably, the hydrophobic ethylenically unsaturated monomers are selected from the group consisting of: butyl (meth)acrylate, hexyl (meth)acrylate, 2-ethylhexyl (meth)acrylate, lauryl (meth)acrylate, N-butyl (meth)acrylamide, N-hexyl (meth)acrylamide, N-lauryl (meth)acrylamide, vinyl laurate, diisobutylene, styrene, and mixtures thereof.

The polymers of this invention may contain additional polymerizable monomers other than (i), (ii) and (iii). The monomers can be selected from the group consisting of: hydroxyethyl (meth)acrylate, (meth)acrylamide, N-(2-hydroxypropy) (meth)acrylamide, 4-styrenesulfonic acid, 2-acrylamido-2-methyl-1-propanesulfonic acid, 2-propene-1-sulfonic acid, 3-sulfopropyl methacrylate, N-vinyl pyrrolidone, N-vinyl caprolactam, N-vinyl oxazolidinone, vinyl acetate, ethyl (meth)acrylate, methyl (meth)acrylate, and mixtures thereof. Alternatively, the additional polymerizable monomer may be selected to promote faster biodegradability such as with the monomer described in WO 93/21243.

Preferably, the additional polymerizable monomer other than (i), (ii) and (iii) is selected from hydroxyethyl acrylate and hydroxyethyl methacrylate (HEMA).

One preferred example of a vinyl addition polymer of the present invention is a vinyl addition polymer comprising, as polymerized units: (a) from about 5 to about 40% by weight of the polymer of a monoethylenically unsaturated (C₃-C₆) carboxylic acid; (b) from about 35 to about 65% by weight of the polymer of a (C₄-C₁₂) alkyl (meth)acrylate ester; and (c) from about 20 to about 60% by weight of the polymer of an alkoxylated (meth)acrylate monomer having the following formula:

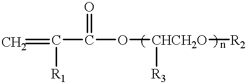

wherein: R₁ is H or CH₃; n is from 2 to 30; R₂ is H or a (C₁-C₆) alkyl group; and R₃ is H or CH₃.

Another preferred example of a vinyl addition polymer of the present invention is a vinyl addition polymer comprising, as polymerized units: (a) from about 10 to about 30% by weight of the polymer of acrylic acid; (b) from about 40 to about 60% by weight of the polymer of butyl acrylate; and (c) from about 30 to about 50% by weight of the polymer of an alkoxylated (meth)acrylate monomer having the following formula:

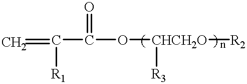

wherein: R₁ is CH₃; n is from 4 to 9; R₂ is CH₃; and R₃ is H.

The vinyl addition polymer can be incorporated into a range of different compositions and/or products including, but not limited to, heavy duty detergent compositions, fabric care compositions (excluding fabric conditioners) and dryer-added compositions, such as fabric cleaning/refreshing compositions for use in the dryer. These compositions and/or products may be in any form known to those skilled in the art. For examples, the compositions and/or products may be in liquid, granular, powder, tablet, paste, foam and bars. These compositions and/or products may be neat or releasably absorbed or adsorbed on to a substrate, such as a woven or non-woven filament substrate.

Preferably, the detergent compositions of the present invention are alkaline. The term “alkaline” refers to the pH being greater than 7 at 25° C. when the detergent composition is dissolved as a 1% by weight solution in water. Typically, heavy duty liquid detergent compositions have pH levels between 7.5-9, and heavy duty granule detergents have pH levels between 9.5-11.

It is important for the polymers of the present invention to be compatible in the detergent formulations. For heavy duty liquid detergents, it is important for the polymers to remain soluble in the formulation, as well as to not adversely affect the detergent's viscosity. Current heavy duty liquid detergents are concentrated and often uses cosolvents to modify the viscosity to be readily pourable. Increased viscosity can lead to formulations that are not readily poured or dispensed, or require additional cosolvents at a non-valued added expense.

Polymers of the present invention provide cleaning and whiteness maintenance benefits without significantly increasing the heavy duty liquid detergent viscosity. Preferably, the vinyl addition polymers have a Polymer Viscosifying Factor is less than 1.5. The Polymer Viscosifying Factor is the ratio of the viscosity (cP) for the liquid laundry detergent composition containing the polymer to the viscosity of the identical formula excluding the polymer. Four hundred mL of the liquid laundry detergent composition is measured in a 600 mL low form Griffin type beaker at 25° C. with a Brookfield DV−II+ spindle viscometer. Spindle type and spindle speed are chosen such that the % scale is greater than 10% and less than 90%. The viscosity of the comparative detergent compositions are measured using the same spindle and spindle speed after a 3 min period.

Preferably, the vinyl addition polymers of the present invention have a molecular weight of 100,000 or less, more preferably 75,000 or less, most preferably 50,000 or less. Typically the vinyl addition polymer has a molecular weight of between about 1,000 and about 100,000, more preferably between about 1,000 and about 50,000.

The molecular weight of the vinyl addition polymers of the present invention are determined using a Gel Filtration Chromatography (GFC) Method. Under this GFC Method, polymers are separated using GFC columns to determine molecular weight distribution. The molecular weight and distributions are measured through separation of the polymer species based on their hydrodynamic volumes. The hydrodynamic volume is related to molecular weight.

A detailed example of how the molecular weights of the vinyl addition polymers of the present invention are determined follows. A 0.2% solution of the vinyl addition polymer is first prepared in the aqueous mobile phase, 80/20 0.5M Ammonium Acetate/Methanol at pH 3.7. The solution is then injected onto the GFC column at 60° C. and its absolute molecular weight and molecular weight distribution are calculated using both multi-angle laser light scattering (MALLS) and refractive index (RI) detection. Theoretical and practical examples of molecular weights determined by the GFC Method are found in: W. W. Yau, J. J. Kirkland, and D. D. Bly, Modern Size-Exclusion Liquid Chromatography, John Wiley & Sons, New York, 1979.

The vinyl addition polymers may be made by any known technique. For example, when the vinyl addition polymers of the present invention are prepared by solution polymerization, the selected monomers are mixed in the presence of a polymerization initiator, a diluent and optionally a chain transfer agent. The reaction can be run under agitation in an inert atmosphere at a temperature of from about 60 to about 140° C., and more preferably from about 85 to about 105° C. The reaction is run generally for about 4 to about 10 hours or until the desired degree of polymerization has been reached. When the polymerization is run as a cofeed process, the initiator and monomers are typically introduced into the reaction mixture as separate feed streams that are added linearly over time, i.e., at constant rates. Generally, the feeds are conducted for periods of time from about 5 minutes to about 5 hours, more preferably from about 30 minutes to about 4 hours, even more preferably from about 1 hour to about 3 hours. As is recognized by those skilled in the art, the time and temperature of the reaction are dependent on the choice of initiator and can be varied accordingly.

Initiators useful for these polymerizations are any of the well known free-radical-producing compounds such as peroxy, hydroperoxy and azo initiators including for example, acetyl peroxide, benzoyl peroxide, lauroyl peroxide, t-butyl peroxyiso-butyrate, caproyl peroxide, cumene hydroperoxide, 1,1-di(t-butylperoxy)-3,3,5-trimethylcyclohexane, azobisisobutyronitrile, t-butyl peroxy pivalate and t-butyl peroctoate. The initiator concentration is normally between about 0.1 and about 6% by weight based on the total weight of the monomers and more preferably from about 0.5 to about 4%. Chain transfer agents may also be added to the polymerization reaction to control the molecular weight of the vinyl addition polymers of the present invention.

Water soluble redox initiators may also be used. Redox initiators include, for example, sodium bisulfite, sodium sulfite, hypophosphites, phosphites, isoascorbic acid, sodium formaldehyde-sulfoxylate and hydroxylamines, used in conjunction with suitable oxidizing agents, such as the thermal free-radical initiators noted above. The redox initiators are typically used in amounts from about 0.05 to about 10%, preferably from about 0.5 to about 5%, based on the weight of total monomer. Combinations of initiators can also be used.

Polymerization processes for the preparation of the vinyl addition polymers of the present invention generally result in good conversion of the monomers into polymer product. However, if residual monomer levels in the polymer mixture are undesirably high for a particular application, their levels can be reduced by any of several techniques. One common method for reducing the level of residual monomer in a polymer mixture is the post-polymerization addition of one or more initiators or reducing agents to assist scavenging of unreacted monomer.

Preferably, any post-polymerization additions of initiators or reducing agents are conducted at or below the polymerization temperature. The initiators and reducing agents suitable for reducing the residual monomer content are well known to those skilled in the art. Generally, any of the initiators suitable for the polymerization are also suitable for reducing the residual monomer content of the polymer mixture. The level of initiators or reducing agents added as a means for reducing the residual monomer content should be as low as possible to minimize contamination of the polymer product. Generally, the level of initiator or reducing agent added to reduce the residual monomer content is in the range of from about 0.1 to about 2.0 mole %, preferably from about 0.5 to about 1.0 mole %, based on the total amount (moles) of polymerizable monomer.

U.S. Pat. No. 3,037,952 may be consulted for further general and specific details on methods to prepare emulsion polymers of the present invention. U.S. Pat. Nos. 4,230,844 and 4,797,223 may be consulted for further general and specific details on methods to prepare polymers of the present invention via solution (solvent) polymerization. Further general and specific details on preparation of polymers of the present invention by solution polymerization followed by phase inversion may be found in Progress in Organic Coatings, 29, p 211 (1996) and Progress in Organic Coatings, 26, p 207 (1995).

Laundry Detergent Composition

The vinyl addition polymer of the present invention is preferably incorporated with one or more additional adjunct ingredients into one or more laundry detergent compositions. Preferably, the laundry detergent compositions of the present invention are free of aminopolyureylene resin because unlike prior art laundry detergent compositions the vinyl addition polymers and systems and compositions of the present invention exhibit relatively dilute efficacy and do not require a resin to attach the vinyl addition polymers to a substrate to be efficacious.

These one or more additional adjunct ingredients are determined according to the type of composition that the vinyl addition polymer is to be incorporated into and/or the type of use of the laundry detergent composition.

The vinyl addition polymer can be incorporated into a range of different compositions and/or products including, but not limited to, heavy duty detergent compositions, fabric care compositions (excluding fabric conditioners) and dryer-added compositions. These compositions and/or products may be in any form known to those skilled in the art. For examples, the compositions and/or products may be in liquid, granular, powder, tablet, paste, foam and bars. These compositions and/or products may be neat or releasably absorbed or adsorbed on to a substrate, such as a woven or non-woven filament substrate.

Adjunct Ingredients

In addition to the vinyl addition polymer, one or more adjunct ingredients may optionally, but preferably, be included in the compositions, products and/or systems comprising the vinyl addition polymer.

Examples of suitable adjunct ingredients include, but are not limited to, surfactants, builders, bleaches, bleach activators, bleach catalysts, enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, fabric conditioners, hydrolyzable surfactants, preservatives, anti-oxidants, anti-shrinkage agents, anti-wrinkle agents, germicides, fungicides, color speckles, silvercare, anti-tarnish and/or anti-corrosion agents, alkalinity sources, solubilizing agents, carriers, processing aids, pigments and pH control agents as described in U.S. Pat. Nos. 5,705,464, 5,710,115, 5,698,504, 5,695,679, 5,686,014 and 5,646,101. Specific cleaning adjunct materials are exemplified in detail hereinafter.

### Methods of the Present Invention

A method for treating a fabric (i.e., removing stains, whitening) comprising contacting the fabric with laundry detergent composition in accordance with the present invention, such that fabric is treated.

### Treated Fabric

A treated fabric results the methods of the present invention.

### Product/Instructions of Use

This invention also may encompass the inclusion of instructions on the use of the laundry detergent compositions described herein with the packages containing the laundry detergent compositions or with other forms of advertising associated with the sale or use of the laundry detergent compositions. The instructions may be included in any manner typically used by consumer product manufacturing or supply companies. Examples include providing instructions on a label attached to the container holding the system and/or composition; on a sheet either attached to the container or accompanying it when purchased; or in advertisements, demonstrations, and/or other written or oral instructions which may be connected to the purchase or use of the laundry detergent compositions.

Specifically the instructions will include a description of the use of the laundry detergent composition. The instructions, for instance, may additionally include information relating to the recommended amount of laundry detergent composition to apply to the fabric, if soaking or rubbing is appropriate to the fabric; the recommended amount of water, if any, to apply to the fabric before and after treatment; other recommended treatment.

The laundry detergent composition may be incorporated into a product, the product may be a kit comprising the laundry detergent composition. Accordingly, a product comprising a laundry detergent composition of the present invention, the product further including instructions for using the laundry detergent composition to treat a fabric in need of treatment.

Nonlimiting examples of suitable products and/or compositions in which the vinyl addition polymers may be used may be in any product form known to those of ordinary skill in the art, such as granules, powder, paste, foam, tablets, dimple tablets, bars, sprays, liquids, dryer-added forms, impregnated sheets, coated sheets, gels, etc. The products and/or compositions in which the vinyl addition polymers may be used include, but are not limited to, heavy duty liquid compositions (TIDE commercially available from The Procter & Gamble Company), heavy duty granule or powder compositions (i.e., TIDE commercially available from The Procter & Gamble Company), fabric treatment compositions (i.e., DRYEL commercially available from The Procter & Gamble Company) and fabric care compositions, other than fabric conditioners.

The following examples are illustrative of the present invention, but are not meant to limit or otherwise define its scope. All parts, percentages and ratios used herein are expressed as percent weight unless otherwise specified.

Polymer Examples

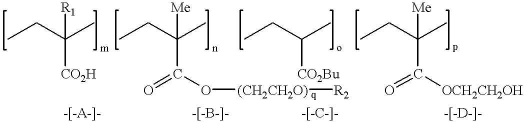

| | Wt % | | | | |
|---|---|---|---|---|---|
| Ex- | -[-A-]- | -[-B-]- | -[-C-]- | -[-D-]- | |
| ample | m | n | o | p | Components |
| I | 25 | 29 | 46 | — | R₁ = H, R₂ = Me, q = 4 |
| II | 21 | 28 | 51 | — | R₁ = H, R₂ = Me, q = 4 |
| III | 16 | 22 | 62 | — | R₁ = H, R₂ = Me, q = 4 |
| IV | 10 | 40 | 50 | — | R₁ = H, R₂ = Me, q = 4 |
| V | 5 | 45 | 50 | — | R₁ = H, R₂ = H, q = 4 |
| VI | 32 | 44 | 24 | — | R₁ = H, R₂ = Me, q = 9 |
| VII | 17 | 42 | 41 | — | R₁ = H, R₂ = Me, q = 9 |
| VIII | 13 | 40 | 47 | — | R₁ = H, R₂ = Me, q = 9 |
| IX | 5 | 50 | 45 | | R₁ = H, R₂ = Me, q = 9 |
| X | 17 | 38 | 45 | — | R₁ = Me, R₂ = Me, q = 9 |
| XI | 13 | 40 | 47 | — | R₁ = H, R₂ = H, q = 9 |
| XII | 19 | 68 | 13 | — | R₁ = H, R₂ = C₁₂, q = 23 |
| XIII | 11 | 70 | 19 | — | R₁ = Me, R₂ = C₁₂, q = 23 |
| XIV | 7 | 67 | 26 | — | R₁ = Me, R₂ = C₁₂, q = 23 |
| XV | 13 | 39 | 48 | — | R₁ = Me, R₂ = Me, q = 23 |
| XVI | 10 | 40 | 50 | | R₁ = Me, R₂ = Me, q = 23 |
| XVII | 24 | 8 | 43 | 25 | R₁ = H, R₂ = Me, q = 9 |
| XVIII | 14 | 8 | 55 | 23 | R₁ = H, R₂ = Me, q = 9 |
| XIX | 5 | 20 | 50 | 25 | R₁ = H, R₂ = Me, q = 9 |

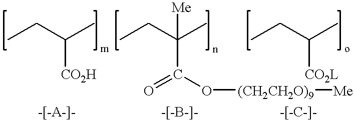

| | Wt % | | | |
|---|---|---|---|---|
| | -[-A-]- | -[-B-]- | -[-C-]- | |
| Example | m | n | o | Components |
| XX | 10 | 40 | 50 | L = C₆ |
| XXI | 10 | 40 | 50 | L = C₈ (2-ethylhexyl) |
| XXII | 10 | 40 | 50 | L = C₁₂ |

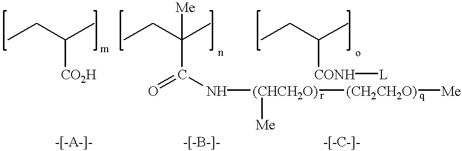

| | Wt % | | | |
|---|---|---|---|---|
| | -[-A-]- | -[-B-]- | -[-C-]- | |
| Example | m | n | o | Components |
| XXIII | 5 | 70 | 25 | r = 1.6, q = 18.6, L = C₄ |
| XXIV | 5 | 70 | 25 | r = 10, q = 31, L = C₄ |

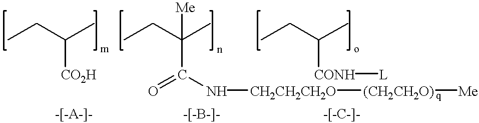

| | Wt % | | | |
|---|---|---|---|---|
| | -[-A-]- | -[-B-]- | -[-C-]- | |
| Example | m | n | o | Components |
| XXV | 10 | 40 | 50 | r = 0, q = 9, L = C₄ |
| XXVI | 10 | 40 | 50 | r = 0, q = 9, L = C₁₂ |

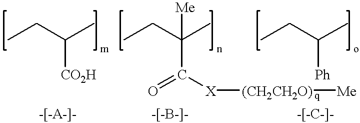

| | Wt % | | | |
|---|---|---|---|---|
| | -[-A-]- | -[-B-]- | -[-C-]- | |
| Example | m | n | o | Components |
| XXVII | 10 | 40 | 50 | X = O, q = 9 |
| XXVIII | 10 | 40 | 50 | X = NH, q = 9, |
| XXIV | 5 | 70 | 25 | X = O, q = 23 |
| XXX | 5 | 70 | 25 | X = NH, q = 23 |

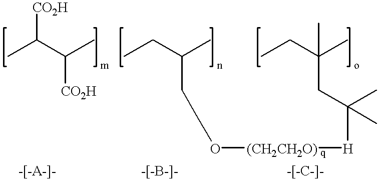

| | Wt % | | | |
|---|---|---|---|---|
| | -[-A-]- | -[-B-]- | -[-C-]- | |
| Example | m | n | o | Components |
| XXXI | 46 | 18 | 36 | q = 4 |
| XXXII | 40 | 19 | 41 | q = 4 |
| XXXIII | 32 | 50 | 18 | q = 10 |
| XXXIV | 39 | 31 | 30 | q = 10 |

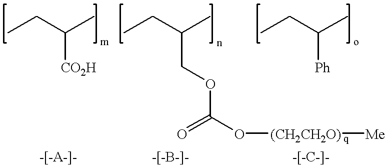

| | Wt % | | | |
|---|---|---|---|---|
| | -[-A-]- | -[-B-]- | -[-C-]- | |
| Example | m | n | o | Components |
| XXXV | 10 | 30 | 60 | q = 4 |
| XXXVI | 10 | 50 | 40 | q = 9 |
| XXXVII | 5 | 70 | 25 | q = 23 |

Formulation Examples

### EXAMPLE 1

Powder heavy duty detergents in use (ppm) and neat product (% by wt.) in accordance with present invention are prepared as follows:

| | A | A | B | B | C | C |
|---|---|---|---|---|---|---|
| Ingredient | PPM | Wt % | PPM | Wt % | PPM | Wt % |
| Surfactant | | | | | | |
| Na LAS | 384 | 25.10 | 300 | 21.20 | 222 | 15.86 |
| Na AS | 96 | 6.27 | 120 | 8.48 | 182 | 13.01 |
| Nonionic | 18 | 1.18 | 16 | 1.13 | 15 | 1.07 |
| Builder | | | | | | |
| Aluminosilicate | 902 | 58.95 | 800 | 56.54 | 702 | 50.16 |
| Chelant | | | | | | |
| DTPA | 13 | 0.85 | 13 | 0.92 | 17 | 1.21 |
| Brightener | | | | | | |
| Br-64 | 4.5 | | 45 | 3.18 | 6.8 | 0.49 |
| Bleach | | | | | | |
| NOBS | 28 | 1.83 | 28 | 1.98 | 92 | 6.57 |
| PB1 or | 37 | 2.42 | 37 | 2.61 | 65 | 4.64 |
| Percarbonate | | | | | | |
| Whitening/ | | | | | | |
| Dye Transfer | | | | | | |
| Vinyl Addition | 15 | 0.98 | 45 | 3.18 | 60 | 4.29 |
| Polymer | | | | | | |
| PVNO | 5.3 | | 5 | | 5.3 | |
| PVPVI | 5.3 | | 5 | | 5.3 | |
| Enzyme | | | 1 | | | |
| Suds Suppressor | 22 | 1.44 | | | 27 | 1.93 |

| | | |
|---|---|---|
| Balance | Balance | Balance |
| (water | (water | (water |
| and | and | and |
| minors) | minors) | minors) |

### EXAMPLE 2

### Granular Detergent Test Composition Preparation

Several heavy duty granular laundry and/or fabric care compositions (excluding fabric conditioners) are prepared containing various vinyl addition polymers in accordance with the present invention. These granular laundry and/or fabric care compositions (excluding fabric conditioners) all have the following basic formula:

TABLE A

| Component | Wt. % |
|---|---|
| C₁₂ Linear alkyl benzene sulfonate | 9.31 |
| C₁₄₋₁₅ alkyl ether (0.35 EO) sulfate | 12.74 |
| Zeolite Builder | 27.79 |
| Sodium Carbonate | 27.31 |
| PEG 4000 | 1.60 |
| Dispersant | 2.26 |
| C₁₂₋₁₃ Alcohol Ethoxylate (9 EO) | 1.5 |
| Sodium Perborate | 1.03 |
| Soil Release Polymer | 0.41 |
| Enzymes | 0.59 |
| Vinyl Addition Polymer | 3.0 |
| Perfume, Brightener, Suds Suppressor, Other | Balance |
| Minors, Moisture, Sulfate | |
| | 100% |

### EXAMPLE 3

### Liquid Detergent Test Composition Preparation

Several heavy duty liquid laundry and/or fabric care compositions (excluding fabric conditioners) are prepared containing various vinyl addition polymers in accordance with the present invention. These liquid laundry and/or fabric care compositions (excluding fabric conditioners) all have the following basic formula:

TABLE B

| Component | Wt. % |
|---|---|
| C₁₂₋₁₅ alkyl ether (2.5) sulfate | 38 |
| C₁₂ glucose amide | 6.86 |
| Citric Acid | 4.75 |
| C₁₂₋₁₄ Fatty Acid | 2.00 |
| Enzymes | 1.02 |
| MEA | 1.0 |
| Propanediol | 0.36 |
| Borax | 6.58 |
| Dispersant | 1.48 |
| Na Toluene Sulfonate | 6.25 |
| Vinyl Addition Polymer | 3.0 |
| Dye, Perfume, Brighteners, Preservatives, Suds | Balance |
| Suppressor, Other Minors, Water | |
| | 100% |

### EXAMPLE 4

Liquid Fabric Cleaning Compositions

Example No.

| Component | A | B |
|---|---|---|
| MEA | 0.48 | 9.0 |
| NaOH | 4.40 | 1.0 |
| Pdiol | 4.00 | 10.0 |
| Citric acid | 2.50 | 2.0 |
| Sodium bicarbonate | 1.0 | 0.5 |
| Sodium sulfate | 1.75 | — |
| DTPA | 0.50 | 1.0 |
| FWA Premix (Br 15/MEA/N1 23-9) | 0.15 | 0.15 |
| Na C25AE1.80S | 23.50 | — |
| AE3S (H) | — | 4.0 |
| C11.8HLAS | 3.00 | 14.0 |
| Neodol | 2.00 | 6.0 |
| EtOH | 0.50 | 2.0 |
| Ca*Formate | 0.10 | 0.1 |
| Borax premix (Borax/MEA/Pdiol/CitricAcid) | 2.50 | — |
| Boric acid | — | 1.0 |
| C10 APA | 1.50 | — |
| TEPA 105 | 1.20 | — |
| FA C12-18 | 5.00 | — |
| Neptune LC | 0.50 | — |
| Dye | 0.0040 | 0.0015 |
| Cellulase | 0.053 | 0.2 |
| Amylase | 0.15 | 0.2 |
| Protease | 0.1 | 0.1 |
| DC 2-3597 | 0.12 | 0.2 |
| Rapeseed FA | 6.50 | 4.0 |
| Vinyl Addition Polymer | 0.05 | 10.0 |

| | |
|---|---|
| Waters and minors | up to 100% |

### EXAMPLE 5

A heavy duty aqueous liquid detergent composition in accordance with the present invention is prepared in a dual-compartment container as follows (the dual compartment container is designed to deliver preferably a 4:1 weight ratio of the first compartment product vs the second compartment product):

| | |
|---|---|
| First Compartment | |
| MEA | 1.10 |
| C10 APA | 0.50 |
| Na C25AE1.80S | 19.35 |
| Propylene Glycol | 7.50 |
| Neodol 23-9 | 0.63 |
| FWA-15 | 0.15 |
| Na Toluene Sulfonate | 2.25 |
| NaOH | 2.79 |
| N-Cocoyl N-Methyl Glucamine | 2.50 |
| Citric Acid | 3.00 |
| C12-16 Real Soap | 2.00 |
| Borax Premix | 2.50 |
| EtOH | 3.25 |
| Ca Formate | 0.09 |
| Polyethyleneimine (MW 600) ethoxylated and | 1.30 |
| average of 20 times per nitrogen | |
| Ethoxylated Tetraethylene-Pentaimine | 0.60 |
| Na Formate | 0.115 |
| Fumed Silica Premix | 0.0015 |
| Soil Release Polymer | 0.08 |
| Blue Liquitint 65 | 0.016 |
| Protease | 1.24 |
| Cellulase | 0.043 |
| Amylase | 0.15 |
| Silicone | 0.119 |
| Neptune LC | 0.35 |
| DTPA | 0.30 |
| Sodium Bicarbonate (Effervescent agent) | 2.00 |
| Vinyl Addition Polymer | 1.50 |
| Water | balance |
| Second Compartment | |
| NaOH | 3.46 |
| Citric Acid (Acid agent) | 20.90 |
| Titanium Dioxide | 2.50 |
| Xanthan Gum | 0.45 |
| Water | balance |

### EXAMPLE 6

A heavy duty aqueous liquid detergent composition in accordance with the present invention is prepared in a dual-compartment container as follows (the dual compartment container is designed to deliver preferably a 4:1 weight ratio of the first compartment product vs the second compartment product):

| | |
|---|---|
| First Compartment | |
| MEA | 1.10 |
| C10 APA | 0.50 |
| Na C25AE1.80S | 19.35 |
| Propylene Glycol | 7.50 |
| Neodol 23-9 | 0.63 |
| FWA-15 | 0.15 |
| Na Toluene Sulfonate | 2.25 |
| NaOH | 2.79 |
| N-Cocoyl N-Methyl Glucamine | 2.50 |
| Citric Acid | 3.00 |
| C12-16 Real Soap | 2.00 |
| Borax Premix | 2.50 |
| EtOH | 3.25 |
| Ca Formate | 0.09 |
| Polyethyleneimine (MW 600) ethoxylated and | 1.30 |
| average of 20 times per nitrogen | |
| Ethoxylated Tetraethylene-Pentaimine | 0.60 |
| Na Formate | 0.115 |
| Fumed Silica Premix | 0.0015 |
| Soil Release Polymer | 0.08 |
| Blue Liquitint 65 | 0.016 |
| Protease | 1.24 |
| Cellulase | 0.043 |
| Amylase | 0.15 |
| Silicone | 0.119 |
| Neptune LC | 0.35 |
| DTPA | 0.30 |
| Sodium Bicarbonate (Effervescent agent) | 3.00 |
| Vinyl Addition Polymer | 0.5 |
| Water | balance |
| Second Compartment | |
| Phthaloylamino peroxycaproic acid (PAP) | 22.5 |
| Citric Acid (Acid agent) | 5.0 |
| Xanthan Gum | 0.4 |
| Water | balance |

### EXAMPLE 7

Heavy duty aqueous liquid detergent compositions in accordance with the present invention are prepared as follows:

| | | |
|---|---|---|
| Surfactants | | |
| Na C25 AE1.1S Paste | 19.18 | 16.62 |
| Na HLAS | 2.58 | 5.16 |
| NI 23-9 | 2.40 | 2.40 |
| C10 APA | 1.20 | 0.60 |
| (amidopropylamine) | | |
| Amine Oxide | | 0.60 |
| Builders | | |
| Na Citrate | 3.76 | 3.76 |
| Na C12-18 Fatty | 3.50 | |
| Acid | | |
| Enzymes/Stabilizers | | |
| Protease | 0.88 | 0.88 |
| Amylase | 0.11 | 0.11 |
| Cellulase | 0.05 | 0.05 |
| Mannanase | 0.18 | 0.18 |
| Borax/Boric Acid | 2.50 | 2.50 |
| Ca Formate/ | 0.05 | 0.05 |
| CaCl2 | | |
| Performance additives | | |
| Polyethyleneimine | 0.60 | 0.60 |
| (PEI189) | | |
| Polyethyleneimine | 1.20 | 1.20 |
| (PE20) | | |
| DTPA | 0.15 | 0.15 |
| FWA-15 | 0.13 | 0.13 |
| Vinyl Addition | 1.0 | 5.0 |
| Polymer | | |
| Stabilizers | | |
| Ethanol | 2.52 | 2.18 |
| 1, 2 propanediol | 5.56 | 4.97 |
| Glycerine | 1.84 | 2.43 |
| MEA | 2.70 | 2.70 |
| NaOH | | 3.20 |
| Na Formate | 0.10 | 0.10 |
| Suds Suppresser | | |
| DC 2-3000 | | 0.030 |
| DC 1410 | 0.010 | 0.010 |
| Aesthetics | | |
| Dye | 0.00175 | 0.00175 |
| Perfume | 0.28 | 0.28 |
| Water | | |
| Water (Bal to 100%) | | |

### EXAMPLE 8

### Cleaning and Refreshing Compositions

Fabric cleaning/refreshment compositions according to the present invention, for use as dryer-added compositions, are prepared as follows:

| Ingredient | % (wt.) |
|---|---|
| Emulsifier (TWEEN 20)* | 0.5 |
| Perfume | 0.5 |
| KATHON ® | 0.0003 |
| Sodium Benzoate | 0.1 |
| Vinyl Addition Polymer | 0.5 |
| Water | Balance |

*Polyoxyethylene (20) sorbitan monolaurate available from ICI Surfactants.

### EXAMPLE 9

### Cleaning and Refreshing Compositions

Fabric cleaning/refreshment compositions according to the present invention, for use as dryer-added compositions, are prepared as follows:

| Ingredient | % (wt.) | Range (% wt.) |
|---|---|---|
| Water | 98.0 | 95.1-99.9 |
| Perfume | 0.5 | 0.05-1.5 |
| Surfactant | 0.5 | 0.05-2.0 |
| Ethanol or Isopropanol | 0 | Optional to 4% |
| Solvent (e.g. BPP) | 0 | Optional to 4% |
| Vinyl Addition Polymer | 1.0 | 0.01-5.0 |

pH range from about 6 to about 8.

### EXAMPLE 10

### Cleaning and Refreshing Compositions

Fabric cleaning/refreshment compositions according to the present invention, for use as dryer-added compositions, are prepared as follows:

| Ingredient | % (wt.) | % (wt.) | % (wt.) | % (wt.) |
|---|---|---|---|---|
| Perfume | 0 | 0.38 | 0.38 | 0 |
| Surfactant | 0.285 | 0 | 0 | 0.285 |
| Solvent (e.g. BPP) | 2.0 | 0 | 0 | 2.0 |
| KATHON ® | 0.0003 | 0 | 0 | 0 |
| Emulsifier (TWEEN 20)* | 0 | 0.5 | 0.38 | 0 |
| Amine Oxide | 0.0350 | 0 | 0 | 0.0350 |
| MgCl2 | 0.045 | 0 | 0 | 0 |
| MgSO4 | 0 | 0 | 0.058 | 0 |
| Vinyl Addition Polymer | 0.5 | 1.0 | 3.0 | 0.05 |
| Hydrogen Peroxide | 0 | 0 | 0 | 0.6 |
| Citric Acid | 0 | 0 | 0 | 0.05 |
| Proxel GXL | 0 | 0.08 | 0.08 | 0 |
| Bardac 2250 | 0 | 0.2 | 0.2 | 0 |
| 1,2-Propanediol | 0 | 0 | 21.75 | 0 |
| Water | balance | balance | balance | balance |

*Polyoxyethylene (20) sorbitan monolaurate available from ICI Surfactants.

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

The compositions of the present invention can be suitably prepared by any process chosen by the formulator, non-limiting examples of which are described in U.S. Pat. No. 5,691,297 Nassano et al., issued Nov. 11, 1997; U.S. Pat. No. 5,574,005 Welch et al., issued Nov. 12, 1996; U.S. Pat. No. 5,569,645 Dinniwell et al., issued Oct. 29, 1996; U.S. Pat. No. 5,565,422 Del Greco et al., issued Oct. 15, 1996; U.S. Pat. No. 5,516,448 Capeci et al., issued May 14, 1996; U.S. Pat. No. 5,489,392 Capeci et al., issued Feb. 6, 1996; U.S. Pat. No. 5,486,303 Capeci et al., issued Jan. 23, 1996 all of which are incorporated herein by reference.

In addition to the above examples, the cleaning compositions of the present invention can be formulated into any suitable laundry detergent composition, non-limiting examples of which are described in U.S. Pat. No. 5,679,630 Baeck et al., issued Oct. 21, 1997; U.S. Pat. No. 5,565,145 Watson et al., issued Oct. 15, 1996; U.S. Pat. No. 5,478,489 Fredj et al., issued Dec. 26, 1995; U.S. Pat. No. 5,470,507 Fredj et al., issued Nov. 28, 1995; U.S. Pat. No. 5,466,802 Panandiker et al., issued Nov. 14, 1995; U.S. Pat. No. 5,460,752 Fredj et al., issued Oct. 24, 1995; U.S. Pat. No. 5,458,810 Fredj et al., issued Oct. 17, 1995; U.S. Pat. No. 5,458,809 Fredj et al., issued Oct. 17, 1995; U.S. Pat. No. 5,288,431 Huber et al., issued Feb. 22, 1994 all of which are incorporated herein by reference.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A laundry detergent composition comprising (a) a vinyl addition polymer derived from (i) monoethylenically unsaturated C₃₋₈ monocarboxylic acids, C₄₋₈ dicarboxylic acids, their salts and mixtures thereof; (ii) hydrophilic ethylenically unsaturated monomers containing at least one poly(oxyethylene) group; and (iii) hydrophobic ethylenically unsaturated monomers having a water solubility of less than 1%; and (b) one or more cleaning adjunct materials.

2. The laundry detergent composition according to claim 1 wherein said vinyl addition polymer has a number average molecular weight of 100,000 or less.

3. The laundry detergent composition according to claim 1 wherein said one or more cleaning adjunct materials comprises optical brighteners.

4. The laundry detergent composition according to claim 1 wherein said hydrophilic ethylenically unsaturated monomers containing at least one poly(oxyethylene) group wherein the weight fraction of the sum of all oxyethylene groups is greater than 0.55 of the monomer formula weight.

5. The laundry detergent composition according to claim 1 wherein said vinyl addition polymer further comprises a monomer derived from polymerizable ethylenically unsaturated monomers other than monomers derived from (i), (ii) and (iii).

6. The laundry detergent composition according to claim 1 wherein said monoethylenically unsaturated C₃₋₈ monocarboxylic acid, C₄₋₈ dicarboxylic acid, their salts and mixtures thereof is selected from the group consisting of: acrylic acid, methacrylic acid, maleic acid, their salts and mixtures thereof.

7. The laundry detergent composition according to claim 1 wherein said hydrophilic ethylenically unsaturated monomer containing at least one poly(oxyethylene) group is selected from the group consisting of (meth)acrylate esters, N-substituted (meth)acrylamides, vinyl ether, allyl ethers, vinyl carbonates, vinyl carbamates, and mixtures thereof.

8. The laundry detergent composition according to claim 1 wherein said hydrophobic ethylenically unsaturated monomers are selected from the group consisting of: butyl (meth)acrylate, hexyl (meth)acrylate, 2-ethylhexyl (meth)acrylate, lauryl (meth)acrylate, N-butyl (meth)acrylamide, N-hexyl (meth)acrylamide, N-lauryl (meth)acrylamide, vinyl laurate, diisobutylene, and styrene.

9. The laundry detergent composition according to claim 5 wherein said polymerizable ethylenically unsaturated monomers other than (i), (ii) and (iii) are selected from the group consisting of: hydroxyethyl (meth)acrylate, (meth)acrylamide, N-(2-hydroxypropy) (meth)acrylamide, 4-styrenesulfonic acid, 2-acrylamido-2-methyl-1-propanesulfonic acid, 2-propene-1-sulfonic acid, 3-sulfopropyl methacrylate, N-vinyl pyrrolidone, N-vinyl caprolactam, N-vinyl oxazolidinone, and vinyl acetate.

10. The laundry detergent composition according to claim 1 wherein the vinyl addition polymer has a Polymer Viscosifying Factor is less than 1.5.

11. A laundry detergent composition comprising:
(a) 10-75% by wt of at least one anionic, nonionic, cationic, ampholytic, or zwitterionic surfactant and mixtures thereof;
(b) 0.01-1% by wt of at least one fluorescent whitening agent;
(c) 0.01-10% by wt of a water soluble vinyl addition polymer derived from:
I. 1-60% by wt of monoethylenically unsaturated C₃₋₈ monocarboxylic acid, C₄₋₈ dicarboxylic acid, their salts, and mixtures therein;
II. 5-85% by wt of hydrophilic ethylenically unsaturated monomers containing at least one poly(oxyethylene) group wherein the weight fraction of the sum of all oxyethylene groups is greater than 0.55 of the monomer formula weight;
III. 10-85% by wt of hydrophobic ethylenically unsaturated monomer with a water solubility of less than 1%; and
IV. 0-30% by wt of polymerizable ethylenically unsaturated monomers different from I, II, and III.

12. A laundry detergent composition according to claim 11, said vinyl addition polymer has the formula
-[-A-]-ₘ-[—B—]-ₙ-[—C—]-ₒ-[-D-]-ₚ
wherein:
(a) monomer unit -[-A-]- is derived from monoethylenically unsaturated C₃₋₈ monocarboxylic acid, C₄₋₈ dicarboxylic acid, their salts, and mixtures therein;
(b) monomer unit -[—B—]- is derived from a hydrophilic ethylenically unsaturated monomer having the formula R-X-G and R-G wherein:
R is selected from the group consisting of CH₂═C(R₁)— where R₁ is H or C₁₋₄ alkyl;
X is selected from the group consisting of —CH₂—, —(C═O)—, and —OCO—;
G is selected from the group consisting of —O—(E)_{q}—R₂ and —N(R₁)—(E)_{q}—R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;
(c) monomer unit -[—C—]— is derived from a hydrophobic ethylenically unsaturated monomer having the formula R-Y-L and R-Z wherein:
Y is selected from the group consisting of —CH₂—, —CO₂—, —OCO—, and —CON(R₁)—;
L is selected from the group consisting of saturated C₂₋₂₀ alkyl, C₆₋₁₂ aryl, and C₇₋₂₀ alkylaryl group;
Z is selected from the group consisting of C₆₋₁₂ aryl and C₇₋₁₂ arylalkyl group;
(d) monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-_{m-[—B—]-}ₙ-[—C—]-ₒ-[-D-]-ₚ being 100 percent, it being understood that the -[-A-]-, -[—B—]-,-[—C—]-, and -[-D-]- monomers can be arranged in any sequence; and the polymer having a number average molecular weight from 1000 to 100,000.

13. A laundry detergent composition according to claim 12 which is sufficiently alkaline such that upon dilution to 1% with water has a pH greater than 7 at 25° C.

14. A laundry detergent composition according to claim 12 wherein n and o are selected such that -[—B—]- and -[—C—]- are at least 20% by wt of the polymer.

15. A laundry detergent composition according to claim 12 wherein R₂ is selected from the group consisting of H— or C₁₋₈ alkyl, preferably R₂ is H— or Me—.

16. A liquid laundry detergent composition according to claim 12 wherein said vinyl addition polymer has a Polymer Viscosifying Factor is less than 1.5.

17. A laundry detergent composition according to claim 12 wherein -[-A-]- is selected from the group consisting of acrylic acid, methacrylic acid, maleic acid, their salts, and mixtures therein.

18. A laundry detergent composition according to claim 12 wherein -[—C—]- is selected from the group consisting of butyl (meth)acrylate, hexyl (meth)acrylate, 2-ethylhexyl (meth)acrylate, lauryl (meth)acrylate, N-butyl (meth)acrylamide, N-hexyl (meth)acrylamide, N-lauryl (meth)acrylamide, vinyl laurate, diisobutylene, and styrene.

19. A laundry detergent composition according to claim 12 wherein -[-D-]- is selected from the group consisting of hydroxyethyl (meth)acrylate, (meth)acrylamide, N-(2-hydroxypropy) (meth)acrylamide, 4-styrenesulfonic acid, 2-acrylamido-2-methyl-1-propanesulfonic acid, 2-propene-1-sulfonic acid, 3-sulfopropyl methacrylate, N-vinyl pyrrolidone, N-vinyl caprolactam, N-vinyl oxazolidinone, and vinyl acetate.

20. A laundry detergent composition according to claim 12, wherein said vinyl addition polymer has the formula
-[-A-]-ₘ-[—B—]-ₙ-[—C—]-ₒ-[-D-]-ₚ
wherein:
(a) monomer unit -[-A-]- is derived from acrylic and methacrylic acid;
(b) monomer unit -[—B—]- is derived from methoxypoly(ethylene glycol)₉ methacrylate, methoxypoly(ethylene glycol)₂₃ methacrylate, poly(ethylene glycol)9 methacrylate, and poly(ethylene glycol)₂₃ methacrylate;
(c) monomer unit -[—C—]- is derived from butyl acrylate, and butyl methacrylate; and
(d) monomer unit -[-D-]- is derived from hydroxyethylmethacrylate.

21. A laundry detergent composition according to claim 20 wherein:
(a) monomer unit -[-A-]- comprises from 1 to 30% by weight of the polymer;
(b) monomer unit -[—B—]- comprises at least 10% by wt, preferably at least 20% by weight of the polymer;
(c) monomer unit -[—C—]- comprises at least 20% by wt of the polymer; preferable at least 30% by weight of the polymer; and
(d) monomer unit -[-D-]- comprises 0 to 30% by weight of the polymer.

22. A laundry detergent composition comprising:
(a) 10-75% by wt of at least one anionic, nonionic, cationic, ampholytic, or zwitterionic surfactant and mixtures thereof;
(b) 0.01-1% by wt of at least one fluorescent whitening agent;
(c) 0.01-10% by wt of a water soluble vinyl addition polymer prepared by an emulsion polymerization process.

23. A laundry detergent composition comprising:
(a) 10-75% by wt of at least one anionic, nonionic, cationic, ampholytic, or zwitterionic surfactant and mixtures thereof;
(b) 0.01-1% by wt of at least one fluorescent whitening agent;
(c) 0.01-10% by wt of a water soluble vinyl addition polymer prepared by a solution polymerization process.

24. A method of removing stains from fabrics comprising contacting the stains with a laundry detergent solution, paste, or slurry comprising:
(a) 0.005-75% by wt of at least one anionic, nonionic, cationic, ampholytic, or zwitterionic surfactant and mixtures thereof;
(b) 0.000005-1% by wt of at least one fluorescent whitening agent;
(c) 0.00005-10% by wt of a water soluble vinyl addition polymer derived from:
I. 1-60% by wt of monoethylenically unsaturated C₃₋₈ monocarboxylic acid, C₄₋₈ dicarboxylic acid, their salts, and mixtures thereof;
II. 5-85% by wt of hydrophilic ethylenically unsaturated monomers containing at least one poly(oxyethylene) group wherein the weight fraction of the sum of all oxyethylene groups is greater than 0.55 of the monomer formula weight;
III. 10-85% by wt of hydrophobic ethylenically unsaturated monomer with a water solubility of less than 1%; and
IV. 0-30% by wt of polymerizable ethylenically unsaturated monomers different from I, II, and III.

25. A method of removing stains from fabrics comprising contacting the stains with a laundry detergent solution, paste, or slurry comprising:
(a) 0.005-75% by wt of at least one anionic, nonionic, cationic, ampholytic, or zwitterionic surfactant and mixtures thereof;
(b) 0.000005-1% by wt of at least one fluorescent whitening agent;
(c) 0.00005-10% by wt of a water soluble vinyl addition polymer of the formula
-[-A-]-ₘ-[—B—]-ₙ-[—C—]-ₒ-[-D-]-ₚ
wherein:
I. monomer unit -[-A-]- is derived from monoethylenically unsaturated C₃₋₈ monocarboxylic acid, C₄-₈ dicarboxylic acid, their salts, and mixtures therein;
II. monomer unit -[—B—]- is derived from a hydrophilic ethylenically unsaturated monomer having the formula R-X-G and R-G wherein:
R is selected from the group consisting of CH₂═C(R₁)— where R₁ is H or C₁₋₄ alkyl;
X is selected from the group consisting of —CH₂—, —(C═O)—, and —OCO—;
G is selected from the group consisting of —O—(E)_{q}—R₂ and —N(R₁)—(E)_{q}—R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;
III. monomer unit -[—C—]- is derived from a hydrophobic ethylenically unsaturated monomer having the formula R-Y-L and R-Z wherein:
Y is selected from the group consisting of —CH₂—, —CO₂—, —OCO—, and —CON(R₁)—;
L is selected from the group consisting of saturated C₂₋₂₀ alkyl, C₆₋₁₂ aryl, and C₇₋₂₀ alkylaryl group;
Z is selected from the group consisting of C₆₋₁₂ aryl and C₇₋₁₂ arylalkyl group;
IV. monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-ₘ-[—B—]-ₙ-[—C—]-ₒ-[-D-]-ₚ being 100 percent, it being understood that the -[-A-]-, -[—B—]-, -[—C—]-, and -[-D-]- monomers can be arranged in any sequence; and the polymer having a number average molecular weight from 1000 to 100,000.

26. A method of improving fabric whiteness appearance of a fabric comprising contacting the fabric with a laundry detergent solution comprising:
(a) 50-5000 ppm of at least one anionic, nonionic, cationic, ampholytic, or zwitterionic surfactant and mixtures thereof;
(b) 0.05-5 ppm of at least one fluorescent whitening agent;
(c) 0.5-500 ppm of a water soluble vinyl addition polymer derived from:
I. 1-60% by wt of monoethylenically unsaturated C₃₋₈ monocarboxylic acid, C₄₋₈ dicarboxylic acid, their salts, and mixtures thereof;
II. 5-85% by wt of hydrophilic ethylenically unsaturated monomers containing at least one poly(ethylene glycol) group wherein the weight fraction of the sum of all oxyethylene groups is greater than 0.55 of the monomer formula weight;
III. 10-85% by wt of hydrophobic ethylenically unsaturated monomer with a water solubility of less than 1%; and
IV. 0-30% by wt of polymerizable ethylenically unsaturated monomers different from I, II, and III.

27. A method of improving fabric whiteness appearance of a fabric comprising contacting the fabric with an aqueous laundry detergent solution comprising:
(a) 50-5000 ppm of at least one anionic, nonionic, cationic, ampholytic, or zwitterionic surfactant and mixtures thereof;
(b) 0.05-5 ppm of at least one fluorescent whitening agent;
(c) 0.5-500 ppm of a water soluble vinyl addition polymer of the formula
-[-A-]-ₘ-[—B—]-ₙ-[—C—]-ₒ-[-D-]-ₚ
wherein:
I. monomer unit -[-A-]- is derived from monoethylenically unsaturated C₃₋₈ monocarboxylic acid, C₄₋₈ dicarboxylic acid, their salts, and mixtures therein;
II. monomer unit -[—B—]- is derived from a hydrophilic ethylenically unsaturated monomer having the formula R-X-G and R-G wherein:
R is selected from the group consisting of CH₂═C(R₁)— where R₁ is H or C₁₋₄alkyl;
X is selected from the group consisting of —CH₂—, —(C═O)—, and —OCO—;
G is selected from the group consisting of —O—(E)_{q}—R₂ and —N(R₁)—(E)_{q}—R₂ where E is a poly(C₂₋₄ oxyalkylene) group selected from the group consisting of poly(ethylene glycol), poly(propylene glycol), poly(butylene glycol), and mixtures thereof, R₂ is selected from H, C₁₋₂₀ alkyl, C₇₋₂₀ alkylaryl, and q is selected such that the weight fraction of all oxyethylene groups is greater than 0.55 of the monomer formula weight;
III. monomer unit -[—C—]- is derived from a hydrophobic ethylenically unsaturated monomer having the formula R-Y-L and R-Z wherein:
Y is selected from the group consisting of —CH₂—, —CO₂—, —OCO—, and —CON(R₁)—;
L is selected from the group consisting of saturated C₂₋₂₀ alkyl, C₆₋₁₂ aryl, and C₇₋₂₀ alkylaryl group;
Z is selected from the group consisting of C₆₋₁₂ aryl and C₇₋₁₂ arylalkyl group;
IV. monomer unit -[-D-]- is derived from a carboxylic acid free ethylenically unsaturated monomer or mixture of monomers different than R-X-G, R-G, R-Y-L, and R-Z; and m being selected such that -[-A-]- comprises from about 1-60% by weight of the polymer, n being selected such that -[—B—]- comprises 5-85% by weight of the polymer, o is selected such that -[—C—]- comprises 10-85% by wt of the polymer, and p is selected such that -[-D-]- comprises zero up to 30% by weight of the polymer, the sum of the weight percents of -[-A-]-ₘ-[—B—-]-ₙ-[—C—]-ₒ-[-D-]-ₚ being 100 percent, it being understood that the -[-A-]-, -[—B—]-, -[—C—]-, and -[-D-]- monomers can be arranged in any sequence; and the polymer having a number average molecular weight from 1000 to 100,000.

28. A method for treating a fabric in need of treatment comprising contacting said fabric with the laundry detergent composition according to claim 1.

29. A method for treating a fabric in need of treatment comprising contacting said fabric with the laundry detergent composition according to claim 11.

30. A method for treating a fabric in need of treatment comprising contacting said fabric with the laundry detergent composition according to claim 22.

31. A method for treating a fabric in need of treatment comprising contacting said fabric with the laundry detergent composition according to claim 23.
